(19) United States
(12) Patent Application Publication
(10) Pub. No.: US 2005/0108920 A1
(43) Pub. Date: May 26, 2005

(54) Vapor heat insect killing apparatus

(76) Inventors: Hirofumi Takenoshita, Kagoshima-shi (JP); Shuichi Wakita, Kagoshima-shi (JP); Koji Kitayama, Kagoshima-shi (JP)

Correspondence Address: JANSSON, SHUPE & MUNGER, LTD, 245 MAIN STREET, RACINE, WI, 53403, US

(21) Appl. No.: 10/798,214

(22) Filed: Mar. 11, 2004

(30) Foreign Application Priority Data
Nov. 21, 2003 (JP) 2003-392890

(51) Int. Cl. A01M 1/20

(52) U.S. Cl. 43/132.1

(57) ABSTRACT

This invention provides a vapor heat apparatus for treating fruits by killing insects such as, for example, a Mediterranean fruit fly, an orange small fruit fly, a Queensland fruit fly and a melon fruit fly or the like. The invention prevents thermal troubles experienced by fruits undergoing treatment by allowing each of the fruits stored in each of the fruit storing means to reach a predetermined fruit central temperature at substantially the same time. The vapor supplying means and the heat exchanger means are controlled in reference to a sensed signal of the fruit temperature sensing means. When the increase in the fruit central temperature in a certain fruit storing unit is delayed as compared with the increase of the central temperature of the fruits in another fruit storing unit, the relative humidity of the saturated vapor passing in the former fruit storing units is increased increasing thermal conductivity or a feeding amount of the saturated vapor passing in the former fruit storing unit is increased increasing the amount of heat provided to the fruit and increasing the thermal conductivity is to hasten the rise in the fruit central temperature.

### FIELD OF THE INVENTION

This invention relates to an apparatus for killing insects, and, more particularly, a vapor heat apparatus for killing insects like fruit flies.

### RELATED ART

Known vapor heat insect killing methods provide an apparatus in which a fruit processing chamber for circulating vapor heat in a lateral direction is provided with a fruit storing unit where vapor is forcedly flowed from below in a vertical direction, the vapor heat contacting the fruits in the fruit storing unit to kill eggs of fruit flies grown at the raw fruit (for example, refer to Japanese Patent Publication No. Sho 61-1094 (particularly pages 1 to 2, FIGS. 1 and 3).

The aforementioned system includes fruit storing units having a plurality of differential pressure fans installed in the fruit processing chamber, vapor (saturated vapor) generated by a common vapor supplying means, a heat exchanger, a fan for circulating air to the fruit storing units, a sensor for sensing a temperature in the fruit processing chamber, a sensor for sensing a temperature at the center of a fruit and a sensor for sensing the relative humidity, in which system the vapor supplying means and the heat exchanger are controlled in response to the detected signal of the sensor sensing the central temperature of the fruit, and in which after the temperature is increased to the predetermined central temperature of the fruit for a predetermined time the vapor heat processing is carried out to kill eggs of the fruit fly grown at the fruit.

In this system, the fruits harvested at each of growing districts and each of the farmers are classified in reference to the amount of moisture contained in the fruit, degree of ripeness and are further classified for every several hundred kilograms of sizes at each of the pallets and mounted.

Accordingly, when the vapor heating process is carried out in the aforementioned system, the central temperature of the fruits is not increased by a uniform rate due to the amount of moisture, the degree of ripeness and the size of the fruits, and the increase of the central temperature of the fruits in certain fruit storing units is delayed as compared with the increase of the central temperature of fruits in other fruit storing units.

However, the prior art does not provide any procedure for overcoming this problem. Due to this fact, the fruits which quickly reach the predetermined central temperature experience the vapor heating process for a longer period under a high temperature region than the fruits which more slowly reach the predetermined central temperature, resulting in that the fruit suffers from some thermal troubles such as shrinking or its lost color luster or resiliency.

### SUMMARY OF THE INVENTION

This invention overcomes the aforementioned problems of the prior art. It is an object of the present invention to provide a vapor heat apparatus for killing insects such as the Mediterranean fruit fly, orange small fruit fly, Queensland fruit fly and melon fruit fly or the like by more quickly heating fruit in a fruit storing unit where the increase of the central temperature of the fruits has been delayed. In this way, the time necessary for the temperature of each of the fruits stored in each of the fruit storing means to be increased to the predetermined central temperature is set to a substantial same value so as to prevent any thermal troubles in advance.

It has been discovered that when performing the insect killing treatment with vapor, a high relative humidity allows for higher thermal conductivity. Such elevated thermal conductivity may contribute to a quicker increase in the central temperature of the fruits. The more an increased amount of contact of the saturated vapor per unit time against the fruit, similarly, the higher the thermal conductivity for the fruit, and the thermal conductivity may contribute to an increase in the central temperature of the fruits.

The present invention is a vapor heat apparatus for killing fruit flies such as the Mediterranean fruit fly, orange small fruit fly, Queensland fruit fly and melon fruit fly or the like, wherein a plurality of fruit storing units for storing pallets having some fruits stored therein are arranged in a fruit processing chamber. Air conditioner chambers provided with a heat exchanging means and a forced circulation means communicate with every one of the fruit storing units. A plurality of air circulation units are constituted for independently and forcedly blowing air from below to each of the fruit storing units. Each of the air circulating units is provided with a vapor supplying means for providing saturated vapor and the like, a sensing means for sensing a temperature at the center of the fruit, a sensing means for sensing a temperature of the air, and a sensing means for sensing the relative humidity of the air. The relative humidity of the saturated vapor passing in each of the fruit storing units can be controlled by controlling the amount of vapor supplied by the vapor supplying means and the heat exchanging rate of the heat exchanging means in response to the detected signal of the sensing means for sensing the central temperature of the fruits in each air circulating unit.

By independently controlling the vapor supplying means and the heat exchanger means in each air circulating unit in response to the detected signal of the fruit temperature sensing means in each air circulating unit, the rate of increase in the central temperature of the fruits in each specific fruit storing unit is optimized. In other words, fruits which are not quickly heated, i.e., fruits which have central temperatures which rise more slowly in response to heating as compared to the rate of increase in the central temperature of fruits in another fruit storing unit, are exposed to air having a higher relative humidity created by controlling the saturated vapor passing in its fruit storing unit so as to cause the increase in the central temperature of the fruits to occur more quickly. Likewise, fruits which are more sensitive to heat are exposed to air having a lower relative humidity such that their rate of temperature increase is slower.

TABLE 1
Proof Data

| | | Relative | Inside |
|---|---|---|---|
| | | Humidity | Temp. |
| | | % RH | ° C. |
| | 12:30 | | |
| | Central | | |
| | Temp. ° C. | | |
| (1) | 27.0 | 59.6 | 28.3 |
| (2) | 26.8 | 59.4 | 28.2 |
| (3) | 26.0 | 59.3 | 28.1 |
| (4) | 27.5 | 59.3 | 28.3 |
| (5) | 26.5 | 59.2 | 28.1 |
| ΔT | | | |
| | 13:00 | | |
| | Central | | |
| | Temp. ° C. | | |
| (1) | 30.8 | 95.1 | 45.8 |
| (2) | 31.0 | 95.0 | 45.9 |
| (3) | 30.3 | 95.0 | 45.8 |
| (4) | 31.9 | 95.0 | 45.7 |
| (5) | 30.1 | 95.1 | 45.6 |
| ΔT | 1.8 | | |
| | 13:30 | | |
| | Central | | |
| | Temp. ° C. | | |
| (1) | 39.2 | 95.3 | 48.2 |
| (2) | 39.4 | 95.1 | 48.1 |
| (3) | 38.8 | 95.4 | 48.2 |
| (4) | 39.9 | 95.2 | 48.2 |
| (5) | 39.1 | 95.4 | 48.1 |
| ΔT | 1.1 | | |
| | 14:00 | | |
| | Central | | |
| | Temp. ° C. | | |
| (1) | 44.3 | 95.4 | 48.2 |
| (2) | 44.3 | 95.3 | 48.1 |
| (3) | 44.0 | 95.5 | 48.2 |
| (4) | 44.4 | 95.3 | 48.2 |
| (5) | 44.4 | 95.5 | 48.1 |
| ΔT | .04 | | |
| | 14:50 | | |
| | Central | | |
| | Temp. ° C. | | |
| (1) | 47.1 | 96.0 | 48.1 |
| (2) | 47.1 | 96.1 | 48.2 |
| (3) | 47.0 | 96.0 | 48.1 |
| (4) | 47.1 | 96.2 | 48.2 |
| (5) | 47.1 | 96.0 | 48.1 |
| ΔT | 0.1 | | |
| | 15:05 | | |
| | Central | | |
| | Temp. ° C. | | |
| (1) | 47.4 | 96.0 | 48.0 |
| (2) | 47.4 | 96.1 | 48.0 |
| (3) | 47.4 | 96.0 | 48.0 |
| (4) | 47.4 | 96.1 | 48.0 |
| (5) | 47.4 | 96.0 | 48.0 |
| ΔT | 0 | | |
| | 15:55 | | |
| | Central | | |
| | Temp. ° C. | | |
| (1) | 37.7 | 71.0 | 29.4 |
| (2) | 35.7 | 72.0 | 28.6 |
| (3) | 36.3 | 74.0 | 29.0 |
| (4) | 34.8 | 73.0 | 28.5 |
| (5) | 35.1 | 76.0 | 28.3 |
| ΔT | | | |

Table 1 displays data for an experiment in which a mango is utilized as an example of a fruit on which an insect is to be killed. The experiment was performed with an apparatus as shown in FIG. 2, in which insect killing apparatus A includes air chambers 21 provided with a heat exchanging means 4 and a forced circulating means 3 for each of a plurality of fruit storing units 31 which are connected to each other to constitute five separate air circulating units 11.

In Table 1, each of (1), (2), (3), (4) and (5) corresponds to the fruit storing units 31 within each of the five separate air circulation units 11. Each of 12:30, 13:00, 13:30, 14:00, 14:50, 15:05, and 15:55 denotes a measuring time. 15:05 denotes a time starting a natural cooling, 15:55 denotes its finishing time and 12:30 denotes a starting time for a vapor heating process, respectively. When the operation is started at 12:30, the temperature in each of the air circulating units 11 is increased while the heat exchangers 5 are being controlled during a period in which the relative humidity in each of the air circulating units 11 is gradually increased under a predetermined increasing mode (a predetermined increasing rate) in the same manner as that of the aforementioned vapor heating insect killing method.

It has been known in the case of an orange small fruit fly and a melon fruit fly or the like that some eggs and maggots grown at a fruit are killed by the vapor heating process (for example, in the case of mango, such eggs and maggots are killed when the central temperature of the fruits is 47.0° C., relative humidity is 90 to 100%RH, and such conditions are maintained for a processing time of 15 minutes).

It is of course apparent that the specific conditions of the vapor heating process is different for each type of a fruit.

A duration of about 2 hours to 3 hours typically passes under a predetermined increasing mode from the starting of this vapor heat processing during which time the central temperature of the fruits is gradually increased up to 47.0° C. and the relative humidity is gradually increased up to 95% RH or more, after which the process is continued for 15 minutes while the relative humidity is maintained.

In Table 1, 13:00, 13:30, 14:00 and 14:50 denote measuring times in which the central temperature of the fruits is gradually increased up to 47.0° C. and the relative humidity is gradually increased up to 95% RH or more. The noted central temperature is the central temperature of the fruit in each of the air circulation units 11, the noted relative humidity is the relative humidity in each of the air circulation units 11, the noted inside temperature is the temperature inside each of the air circulation units 11, and ΔT denotes the temperature difference between the maximum central temperature of the fruits and the minimum central temperature of the fruits among each of the air circulation units 11.

The central temperature of the fruits in each of the fruit storing units 31 (1), (2), (3), (4) and (5) at the measuring time of 13:00 (after which 30 minutes have elapsed after starting the vapor heating operation) has a variance of fruit central temperatures which range from 30.1° C. to 31.9° C. Thus, the temperature difference at these central temperature of the fruits is 1.8° C.

The intermittent atomization time for vapor in regard to the fruit storing units 31 (1), (2), (3) and (5) shows a delay in the increase of the central temperature of the fruits as compared to the fruits in fruit storing unit (4) which contains the fruit showing the maximum central temperature of the fruits. In response, the heat exchanging rate of the heat exchanger means 4 is increased and the relative humidity is increased until 14:00, resulting in that the central temperature of the fruits within the fruit storing units 31 (1), (2), (3) and (5) approaches the central temperature of the fruits in the fruit storing unit 31 (4) and the temperature difference converges to 0.4° C.

In the case of the present invention, when the temperature difference between the central temperatures of the fruits becomes, for example, 0.5° C. (a set value) or more, the temperature difference is acknowledged such that the air circulation unit 11 storing the fruit having the lower central temperature of the fruits (the modified air circulation unit) shows the delay in increase in temperature in regard to the air circulation unit 11 storing the fruit having the maximum central temperature of the fruits, resulting in that the intermittent atomization time for vapor per predetermined time (the rate of vapor supply) is increased and at the same time a temperature of the heat exchanger means 4 is increased in such a way that the temperature in the modified air circulation unit 11 is not decreased and the relative humidity is increased with respect to the air circulation unit 11 storing the fruit having the maximum central temperature. For example, the temperature difference between the central temperatures of the fruits is 0.5° C. (a set value) or more at 13:00, until which time the intermittent atomization of vapor lasted for 15 seconds per minute for each fruit storing unit 31. In response to the noted temperature difference, the operation in the modified air circulation unit is changed such that the vapor is intermittently atomized for 30 to 50 seconds to increase the amount of vapor, and the rate of the heat exchanger means (heater) 4 is increased by 1 Kw/h to several Kw/h and such increased rates are continued during the period from 13:00 to 14:00.

The rate of vapor supply is increased in proportion to the temperature difference and the rate of the heat exchanging means 4 is increased in proportion to the temperature difference in such a way that the inside temperature in the modified air circulation unit 11 is not cooled.

The time 13:30 denotes a measuring time during the operation at which the temperature difference has already decreased to 1.1° C.

At this point the saturation vapor at the fruit surfaces in the fruit storing units 31 (1), (2), (3) and (5) has increased and the thermal conductivity for increased central temperature of the fruits has improved.

The set value (for example, 0.5° C.) of the central temperature difference of the fruits is always monitored, the vapor supplying means C4 and the heat exchanger means 4 in the corresponding fruit storing unit 31 are controlled as described above every time a value more than the set value is detected at any of the measuring times as a temperature difference between the central temperatures of the fruits. The vapor atomization amount for the fruit storing unit 31 to be targeted and the heating rate of the heat exchanger means 4 are increased in the fruit storing unit having fruits with lower central temperatures and the operation is continued in such a way that the temperature difference converges to a value lower than the set value by 0.5° C.

When the central temperature of the fruits at each of the fruit storing units 31 converges to a value lower than the set value at each of the measuring times, the operation returns back to an increasing mode controlled by the control unit. Each of the vapor supplying means C4 and each of the heat exchanger means 4 are controlled by the control unit such that the relative humidity and the inside temperature are increased at the predetermined increasing rate.

The final vapor heated state is maintained for 15 minutes from the measuring time 14:50 where the central temperature of the fruits converges to 47.0 to 47.1° C. under a relative humidity of about 96% RH, then the units are cooled automatically from the time 15:05 to 15:55 and the vapor heating process is completed.

A controlling operation for controlling each of the vapor supplying means C4 and the heat exchanger means 4 and increasing their temperature at a predetermined increasing rate is set through programming of a memory unit of the control unit in response to the kind of fruit and the set value of the central temperature of the fruits. The intermittent atomization time (rate of vapor supply) and the increased heating rate of the heat exchanger means 4 and the like can be similarly changed through programming the memory unit of the control unit in response to the kind of fruit to be processed.

In preferred embodiments, a vapor amount provided by the vapor supplying means and a heat exchanging rate of the heat exchanger means are controlled in response to a detected signal of the central temperature of the fruits sensing means for every air circulating unit. The relative humidity of saturated vapor passing in each of the fruit storing units is controlled such that when an increase of the central temperature of the fruits in a certain fruit storing unit is delayed as compared with the other fruit stored in another fruit storing unit due to a contained moisture amount, a degree of ripen, size or other factors, the vapor supplying means and the heat exchanger means are controlled to increase the relative humidity, thereby increasing the thermal conductivity. As a result, the rate of change is increased for the central temperature of the fruits which have experienced delayed temperature increase. In this manner the fruit stored in each of the fruit storing units are treated such that they reach the predetermined central temperature at the same time.

The central temperature of the fruits in each of the fruit-storing units is detected and monitored individually by the fruit temperature sensing means. Then, when an increase of the central temperature of the fruits stored in a certain fruit storing unit is delayed compared to the increase of the central temperature of the fruits stored in another fruit storing unit, the intermittent atomization amount is increased from the vapor supplying means and at the same time the heat exchanging rate of the heat exchanger means is increased (the heating rate of a heating source is increased) for the fruit storing unit exhibiting a delayed temperature increase. With such an operation, a relative humidity of saturated vapor passing through the fruit-storing unit is increased to cause the thermal conductivity to be increased and to increase the rate of increase of the central temperature of the fruits.

A plurality of fruit storing units for storing pallets having some fruits installed therein are preferably arranged within the fruit processing chamber, and the air conditioner chambers provided with the heat exchanging means and the forced circulation means are communicated with the fruit processing chamber. At the same time, an air blower means for flowing air from below in each of the fruit storing units is arranged in each of the fruit storing units to enable the vapor to forcedly circulate in each of the fruit storing units and the air conditioner chambers. The fruit processing chambers are provided with a saturated vapor supplying means, a temperature sensing means and a sensing means for sensing a relative humidity. Each of the fruit storing units is provided with a sensing means for sensing a temperature of the center of the fruit, and in the case that an increase in the central temperature of the fruits is delayed as compared with an increase in the central temperature of the fruits in another fruit storing unit, the air blower means for flowing air is triggered to provide an increased amount of the saturated vapor to the fruit storing unit having the delayed temperature increase to cause the rate of increase of the central temperature of the fruits to increase.

TABLE 2
Proof Data

| | | | Relative | Inside |
|---|---|---|---|---|
| | | Air | Humidity | Temp. |
| | | Volume % | % RH | ° C. |
| | 15:16 | | | |
| | Central | | | |
| | Temp. ° C. | | | |
| (1) | 29.0 | 80 | 63.3 | 33.2 |
| (2) | 32.3 | 80 | 63.3 | 33.2 |
| (3) | 30.8 | 80 | 63.3 | 33.2 |
| (4) | 30.3 | 80 | 65.9 | 33.2 |
| (5) | 30.0 | 80 | 65.9 | 33.2 |
| ΔT | | | | |
| | 16:14 | | | |
| | Central | | | |
| | Temp. ° C. | | | |
| (1) | 33.9 | 90 | 95.2 | 45.8 |
| (2) | 34.3 | 85 | 95.2 | 45.8 |
| (3) | 35.1 | 80 | 95.2 | 45.8 |
| (4) | 33.8 | 90 | 95.3 | 46.0 |
| (5) | 33.9 | 90 | 95.3 | 46.0 |
| ΔT | 1.3 | | | |
| | 16:44 | | | |
| | Central | | | |
| | Temp. ° C. | | | |
| (1) | 40.5 | 85 | 95.3 | 47.7 |
| (2) | 40.5 | 85 | 95.3 | 47.7 |
| (3) | 41.4 | 80 | 95.3 | 47.7 |
| (4) | 40.4 | 85 | 95.4 | 48.0 |
| (5) | 40.6 | 85 | 95.4 | 48.0 |
| ΔT | 1.0 | | | |
| | 17:14 | | | |
| | Central | | | |
| | Temp. ° C. | | | |
| (1) | 44.6 | 85 | 95.4 | 47.9 |
| (2) | 44.6 | 85 | 95.4 | 47.9 |
| (3) | 45.0 | 80 | 95.4 | 47.9 |
| (4) | 44.9 | 85 | 95.5 | 48.0 |
| (5) | 44.7 | 85 | 95.5 | 48.0 |
| ΔT | 0.4 | | | |
| | 17:44 | | | |
| | Central | | | |
| | Temp. ° C. | | | |
| (1) | 46.5 | 80 | 95.5 | 47.9 |
| (2) | 46.6 | 80 | 95.5 | 47.9 |
| (3) | 46.7 | 80 | 95.5 | 47.9 |
| (4) | 46.6 | 80 | 95.6 | 48.0 |
| (5) | 46.7 | 80 | 95.6 | 48.0 |
| ΔT | 0.2 | | | |
| | 18:05 | | | |
| | Central | | | |
| | Temp. ° C. | | | |
| (1) | 47.0 | 80 | 95.5 | 48.0 |
| (2) | 47.0 | 80 | 95.5 | 48.0 |
| (3) | 47.2 | 80 | 95.5 | 48.0 |
| (4) | 47.2 | 80 | 95.6 | 48.1 |
| (5) | 47.2 | 80 | 95.6 | 48.1 |
| ΔT | 0.2 | | | |
| | 18:20 | | | |
| | Central | | | |
| | Temp. ° C. | | | |
| (1) | 47.2 | 95.2 | 47.9 | |
| (2) | 47.2 | 95.2 | 47.9 | |
| (3) | 47.4 | 95.2 | 47.9 | |
| (4) | 47.5 | 95.3 | 48.0 | |
| (5) | 47.5 | 95.3 | 48.0 | |
| ΔT | 0.3 | | | |
| | 19:04 | | | |
| | Central | | | |
| | Temp. ° C. | | | |
| (1) | 29.1 | 75.2 | 29.7 | |
| (2) | 29.7 | 75.2 | 29.7 | |
| (3) | 36.1 | 75.2 | 29.7 | |
| (4) | 37.3 | 74.0 | 29.5 | |
| (5) | 36.8 | 74.0 | 29.5 | |
| ΔT | | | | |

Table 2 shows data for an experiment in which a mango is treated to kill insects and eggs. In Table 2, each of (1), (2), (3), (4) and (5) corresponds to the fruit storing units stored in one common fruit processing chamber. As shown in FIG. 5, five fruit storing units 31 ((1), (2), (3), (4) and (5)) are stored in one common fruit processing chamber 1. Air conditioning chambers 21 provided with a heat exchanging means 4 and a forced circulating means 3 are communicated with the fruit processing chamber 1 so as to constitute the vapor heat insect killing apparatus A.

Each of 15:16, 16:14, 16:44, 17:14, 17:44, 18:05, 18:20, and 19:04 denotes a measuring time. 18:20 denotes a time starting a natural cooling, 19:04 denotes the natural cooling finishing time and 15:16 denotes a starting time for a vapor heating process. When the operation is started at 15:16, the temperature in the fruit processing chamber 1 is increased while the heat exchangers 4 are being controlled during a period in which the relative humidity in the fruit processing chamber 1 is gradually increased under a predetermined increasing mode (a predetermined increasing rate) in the same manner as that of the related art vapor heating insect killing method.

In Table 2, 16:14, 16:44, 17:14, 17:44 and 18:05 denote measuring times in which the relative humidity is gradually increased up to 95% RH or more. The noted central temperature is a central temperature in each of the fruit storing units 31, the noted relative humidity is a relative humidity in the fruit processing chamber 1, the noted inside temperature is a temperature in the fruit processing chamber, the noted air volume is an air volume of an air blower means (fan) 9 for flowing air (a rate against the maximum capability), and ΔT denotes a temperature difference between the maximum central temperature of the fruits and the minimum central temperature of the fruits among each of the fruit storing units 31.

The inside temperature in the fruit processing chamber 1 and the relative humidity are increased under the predetermined increasing mode in the same manner as that found in Table 1 while each of the vapor supplying means C4 and the heat exchanger means 4 is controlled by the control unit.

The central temperature of the fruits in each of the fruit storing units 31 (1), (2), (3), (4) and (5) at the measuring time of 16:14 in which one hour has elapsed after starting the vapor heating operation has a range of temperatures ranging from 33.8° C. to 35.1° C. The temperature difference of these central temperature of the fruits is 1.3° C.

The air blowing rate of the air blower means (fan) 9 arranged at the corresponding fruit storing unit 31 in units (1), (2), (4) and (5) is increased in response to the delay in the increase of the central temperature of the fruits as compared against the fruit storing unit 31 (3) which holds the fruit having the maximum central temperature, resulting in that the central temperature of the fruits within fruit storing units 31 (1), (2), (4) and (5) approaches the central temperature of the fruits in fruit storing unit 31 (3) within one hour and the temperature difference converges to 0.4° C.

In the case of the present invention, when the temperature difference between the central temperatures of the fruits becomes, for example, 0.5° C. (a set value) or more, the temperature difference is acknowledged such that the fruit storing unit 31 which holds the fruit of lower temperature shows the delay in increase in temperature with respect to the fruit storing unit 31 which holds the fruit having the maximum central temperature, resulting in that the rate of the air blowing means (fan) 9 is controlled so as to cause the heating rate of the saturated vapor at the surface to be increased to a level higher than that in the fruit storing unit 31 holding the fruit having the maximum central temperature. For example, when a central temperature difference is 0.5° C. (a set value) or more at the measuring time of 16:14, the air blower means (fan) 9 in the fruit storing unit 31 holding the lower temperature fruit is increased from that of the normal operation (80%) and then the operation is continued for one hour until 17:14.

In contrast, in the related art, a feeding amount of the air blower means (fan) 9 is kept constant (80%) at the time of increasing mode described above.

The air blowing rate of the air blower means (fan) 9 described above is set in proportion to the temperature difference.

In Table 2, the time 16:44 denotes a measuring time during the operation and already by this point of the operation, the temperature difference converges down to 1.0° C.

The invention provide that the heating amount at the fruit surfaces in the fruit storing units 31(1), (2), (4) and (5) is increased and a thermal conductivity for an increased central temperature of the fruits is improved.

The set value (for example, 0.5° C.) of the central temperature of the fruits is always monitored, the air blower means (fan) 9 for flowing air in the corresponding fruit storing unit 31 is controlled as described above every time a value more than the set value is detected at any of the measuring times, and the operation is continued.

In Table 2, the air blowing rate of the air blower means (fan) 9 for flowing air in the fruit storing units 31 (1), (2), (4) and (5) is set to 85% for 30 minutes from 17:14 to 17:44, and the temperature difference is converged down to 0.2° C.

When the central temperature of the fruits at each of the fruit storing units 31 converges to a value lower than the set value at each of the measuring times, the operation returns back to an increasing mode controlled by the control unit which controls each of the vapor supplying means C4, the heat exchanger means 4 and the air blower means 9 for flowing air such that the relative humidity and the inside temperature are increased at the predetermined increasing rate.

The vapor heated state is maintained for 15 minutes from the measuring time 18:05 when the central temperature of the fruits converges to 47.0 to 47.2° C. under a relative humidity of about 95.5% RH. Then the fruits are cooled automatically from the time 18:20 to 19:44. The air blowing capability of the air blower means (fan) 9 for blowing air at the time of maintaining the vapor heated state is preferably set to 80%.

A controlling operation for controlling each of the vapor supplying means C4, the heat exchanger means 4 and the air blower means 9 and for increasing temperature at a predetermined increasing rate is set through programming a memory unit of the control unit in response to the kind of fruit being treated. The set value of the central temperature of the fruits and the increased air amount (a feeding amount) of the air blower means 9 can be similarly changed through programming the memory unit of the control unit in response to the kind of fruit to be processed.

When the fruit stored in a certain fruit storing unit shows a slower increase of the central temperature of its fruits compared to the fruits stored in another fruit storing unit due to a contained moisture amount, a degree of ripen or size, a rate of the saturated vapor flowing in the specific fruit storing unit is increased on the basis of the sensing signal of the fruit temperature sensing means, resulting in that the fruits stored in each of the fruit storing units may reach the predetermined central temperature at substantially the same time.

That is, the central temperature of the fruits in each of the fruit-storing units is sensed and monitored individually by the fruit temperature sensing means. Then, in the case that the central temperature of the fruits stored in a certain fruit storing unit is increasing more slowly than the central temperature of the fruits stored in another fruit storing unit, the rate at which saturated vapor is blown into the low-temperature fruit-storing unit is increased by the air blower means to increase the heating amount to increase the central temperature of the fruits more quickly.

The results in Table 1 and Table 2 showed that the maggots and eggs of fruit flies or the like grown at a fruit were dead without producing any shrinking of the fruit, damaging any color luster or resiliency.

In regard to this fact, the above set value is only one example, but for some fruits, when the predetermined temperature difference is set to 1.5° C. or more, it may lead to the central temperature of fruits stored in another fruit storing unit being rapidly increased and this is not preferable.

In such cases, the set value may be set to a value smaller than 0.5° C.

In addition, the set value may be sensed in a smaller incremental manner than that shown in Tables 1 and 2 or by continuously measuring it so as to sense the set value and it may also be applicable to employ a control system starting a controlling operation.

When the fruits stored in a certain fruit storing unit show a slower increase in central temperature compared to the fruits stored in another fruit storing unit due to their contained moisture volume, degree of ripen and size or the like, the vapor supplying means and the heat exchanger means are controlled to cause the relative humidity to be increased and the rate of increase in temperature to be elevated and thus to allow each of the fruits stored in each fruit storing unit to reach a predetermined central temperature in a substantial concurrent manner.

Alternatively, in the case that the fruits stored in a certain fruit-storing unit have a slower increase in central temperature compared to the fruits stored in another fruit storing unit due to their contained moisture content, degree of ripen and sizes or the like, the air blower means (fan) 9 may be controlled such that an amount of air of the saturated vapor (a feeding amount) per unit time passing through the fruit storing unit is increased and a heating amount is increased, thereby each of the fruits stored in the fruit storing unit to reach the predetermined central temperature substantially in a concurrent manner.

Due to this fact, even if the central temperatures increase differently in response to a common environment in every fruit storing unit due to an amount of moisture contained in the stored fruits, degree of ripen and size or the like, it is possible to prevent any thermal trouble of the fruits, keep a predetermined quality and kill the eggs and maggots of fruit flies grown at the fruits.

### BRIEF DESCRIPTION OF THE DRAWINGS

FIG. 1 is a schematic front elevational view in section for showing a vapor heat insect killing device of a first preferred embodiment.

FIG. 2 is a schematic top plan view in cross section of a vapor heat insect killing device of a first preferred embodiment.

FIG. 3 is a schematic sectional view taken along line (3)-(3) of FIG. 1.

FIG. 4 is a schematic front elevational view in section for showing a vapor heat insect killing device of a second preferred embodiment.

FIG. 5 is a schematic top plan view in cross section of a vapor heat insect killing device of a second preferred embodiment.

FIG. 6 is a schematic top plan view in cross section for showing a vapor heat insect killing device of a third preferred embodiment.

### DESCRIPTION OF THE PREFERRED EMBODIMENTS

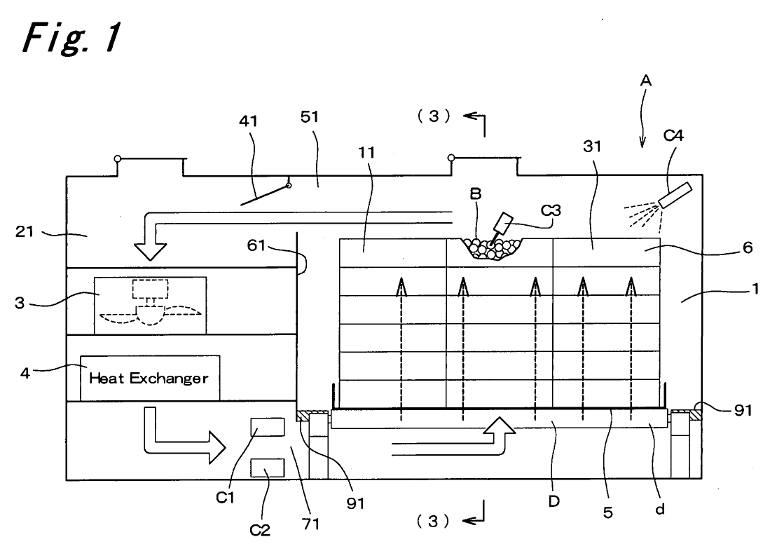

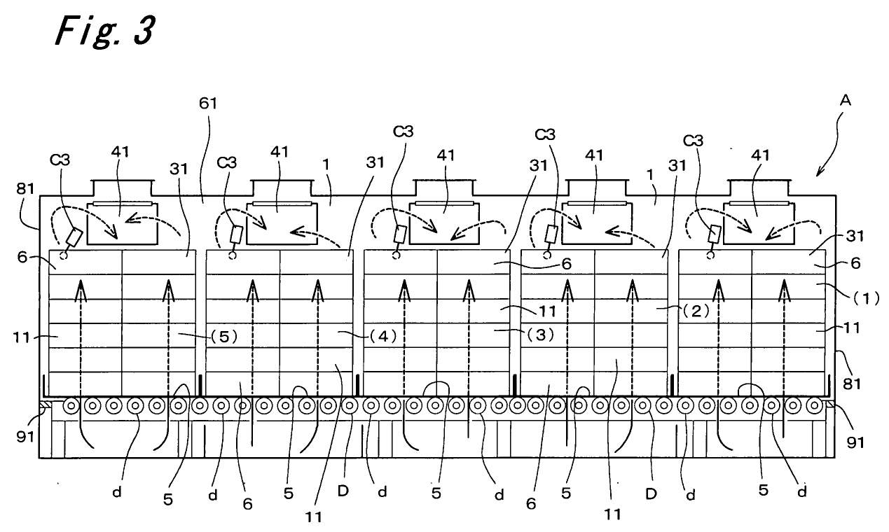

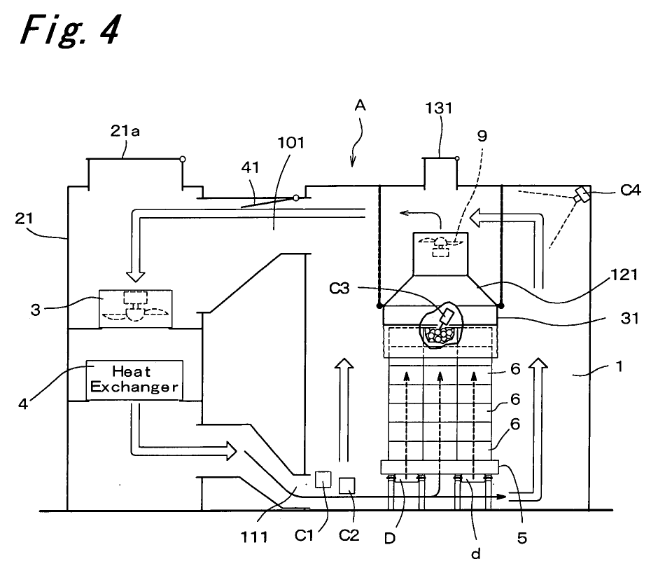

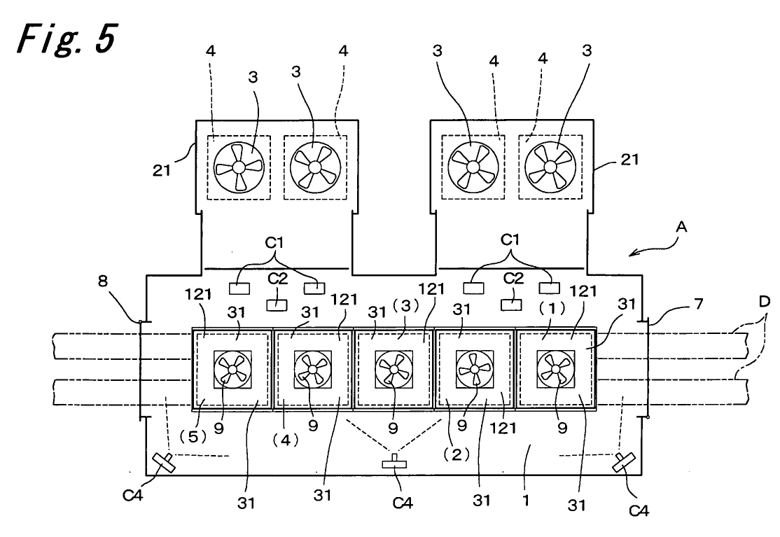

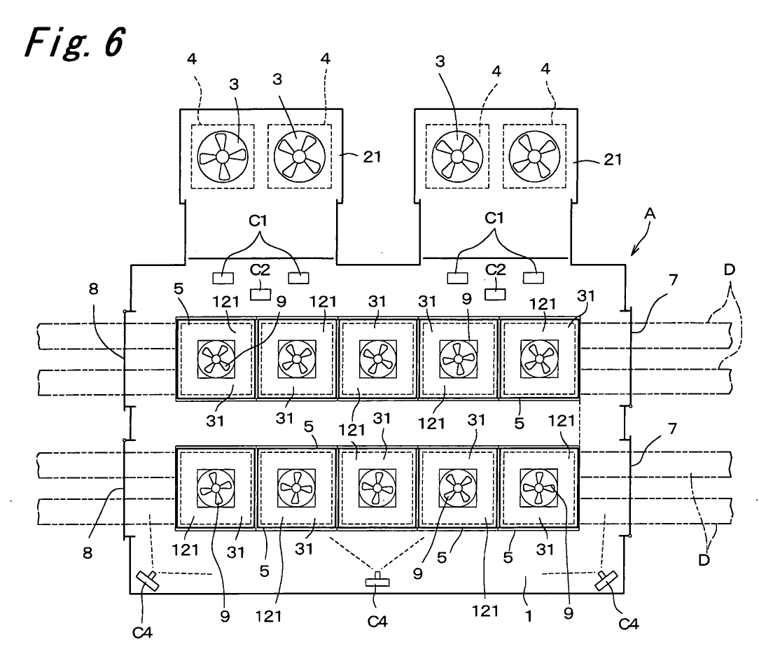

Referring now to FIGS. 1 to 3 showing a first preferred embodiment, FIGS. 4 and 5 showing a second preferred embodiment and FIG. 6 showing a third preferred embodiment, the vapor heat apparatus for killing insects such as a Mediterranean fruit fly, an orange small fruit fly, a Queensland fruit fly and melon fruit fly or the like will be described as follows.

FIGS. 1 to 3 show a preferred embodiment of the vapor heat apparatus for killing insects such as a Mediterranean fruit fly, an orange small fruit fly, a Queensland fruit fly and melon fruit fly or the like wherein reference symbol A denotes a vapor heat insect killing apparatus.

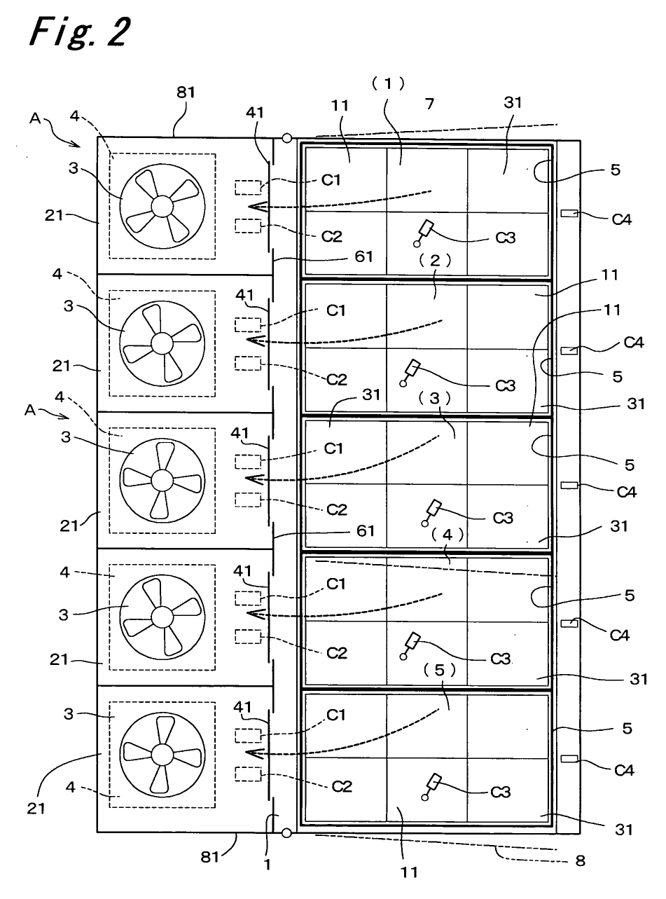

FIGS. 1 to 3 show an arrangement in which a plurality of rows (five rows in the preferred embodiment) of air circulating unit 11, comprised of an air conditioning chamber 21 and a fruit storing unit 31 in communication with the air conditioning chamber, are arranged side by side within the fruit processing chamber 1 having a rectangular shape as seen in a top plan view of FIG. 2.

Each of the air conditioning chambers 21 is constructed such that each of the forced circulating means (fan) 3 and heat exchanging means 4 (preferably provided with a heater, a hot water coil and a cooling coil and the like) are arranged inside the chamber with the forced circulating means 3 being installed at an upper side. Each of the air conditioning chambers is in communication with each of the adjoining fruit storing units 31 at upper side and lower side.

Reference numeral 41 denotes a damper for controlling circulation arranged at an upper part of an interface wall 61 between each of the air conditioning chambers 21 and the fruit storing unit 31 so as to cause an upper side communicating space 51 to be released while cooperating with the operation of either the forced circulating means 3 or the heat exchanger means 4.

In addition, each of the air conditioning chambers 21 is in communication with each other through a lower communicating space 71 opened at a lower part of the interface wall 61 for the fruit storing units 31.

Fruits B having a total mass of about 500 Kg are stored such that each of container cages 6 mounted in multi-stage states on the pallets acting as a frame 5 is separately arranged, wherein the pallets 5 are mounted on a roller conveyor D installed over an inlet 7 and an outlet 8 provided at the opposing side walls 81, 81 of the fruit processing chamber and the fruits B are loaded into the processing chamber in through the fruit storing units 31.

In addition, each of the frames (pallets) 5 as shown in the figure is abutted to each other between each of the fruit storing units 31 as described above, the area having no frame is closed by a baffle plate 91, and a space between each of the rollers (d) in the roller conveyor D below the frame 5 provides an air ascending space.

Each of the air conditioning chambers 21 has a temperature sensing means (a temperature sensor) C1 and a relative humidity sensing means (a relative humidity sensor) C2 at a lower position of the heat exchanger means 4. Each of the fruit-storing units 31 is provided with a fruit central temperature sensing means (a temperature sensor) C3 for sensing the central temperature of the fruits in the upper-most stage container cage 6.

In addition, each of the fruit-storing units 31 is provided with a humidifier acting as the vapor supplying means C4 above the upper-most stage container cage 6. The vapor supplying means C4, each of the sensing means C1, C2 and C3, the forced circulating means 3 and the heat exchanger 4 and the like in communication with a control unit (not shown). A vapor supplying amount and a heat-exchanging rate of the heat exchanger means are controlled by a predetermined program stored in either RAM or ROM in the control unit.

When the apparatus is operated, the forced circulating means 3 and the heat exchanger means 4 mounted in each of the air conditioning chambers 21 are operated together. Air is heat exchanged (heated) by the heat exchanger means 4 in each of the air conditioning chambers 21. The air is divided to flow from the lower communicating space 71 and a space between the roller conveyor D and a floor surface and ascends. The air is fed into each of the fruit storing units 31, passes through a clearance at the frames 5, and passes through the multi-stage container cages 6 while its temperature is decreased by the fruits B. Upon blowing out at the upper part of the space, the air is intermittently accelerated by the vapor supplying means C4, then the air is sucked again from the upper side communicating space 51 into each of the air conditioning chambers 21. After the air is conditioned (heat exchanged) by the heat exchanger means 4, the air passes through the temperature sensing means C1 and the relative humidity sensing means C2 and again the air is fed into each of the fruit storing units 31 to form a circulating flow. It rarely occurs that any of the divided flows is fed into an adjoining fruit storing unit 31 because each of the fruit-storing units 31 is individually communicated with the forced circulating means 3 in the air conditioning chamber 21.

While performing the operation of the apparatus of the present invention, the increasing step 1 (an increasing mode) is first executed.

At this step 1, the vapor is intermittently atomized from the vapor supplying means (a humidifier) C4, the air containing its vapor is heated by the heat exchanger 4 at a predetermined heat exchanging rate increased in a stepwise manner so as to gradually increase a relative humidity of the saturated vapor passing in each of the fruit storing units 31 and an inside temperature and then the central temperature of the fruits in each of the fruit storing units 31 is increased substantially in a concurrent manner up to a predetermined temperature (about 47.0° C.) after elapsing the predetermined time.

Subsequently, a continuing step 2 is executed. In step 2 the predetermined central temperature of the fruits is set and the heat exchanging rate and the vapor supplying amount (an intermittent atomization operation) are automatically selected to achieve the heating amount required for continuously maintaining the predetermined central temperature for a predetermined vapor heat processing time to kill the eggs and maggot of the fruit fly grown at the fruits B. The inside temperature and relative humidity are monitored for each air circulating unit.

During step 1, the central temperature of the fruits B in each of the fruit-storing units 31 is being monitored by each of the fruit central temperature sensing means C3, and if an increase in the central temperature of fruits in a certain fruit storing unit 31 is delayed due to the contained moisture or degree of ripen and size or the like at any point during the monitoring such that a temperature difference more than the set value is detected with respect to the fruits having the maximum fruit central temperature, the operation is transferred to step 3.

At step 3, the frequency of atomization from the vapor generating means C4 into those fruit storing units 31 storing fruits having a delayed central temperature increase is controlled to increase the vapor supplying amount and at the same time the rate of heating by the heat exchanger means 4 is increased such that the relative humidity is prevented from being decreased, and the central temperature of the fruits B in the fruit storing unit 31 is increased. Thus, a relative humidity of the saturated vapor passing in the fruit storing unit 31 storing those fruits B which have a delayed central temperature increase is made higher than a relative humidity of the saturated vapor passing in the fruit storing unit 31 storing fruit having the highest or maximum central temperature for a predetermined period of time, thus, the rate of increase of temperature for the fruit previously having the lower fruit central temperature is further elevated and the temperature difference of the fruit central temperatures is restricted to a value lower than the set value.

This operation is executed automatically every time the temperature difference of the fruit central temperature in each of the fruit storing units 31 becomes more than the set value.

When the difference between the central temperatures is brought to a value lower than the set value, the operation returns back to the step 1 to cause the central temperature of the fruits B stored in each of the fruit storing units 31 to be increased up to a predetermined temperature (about 47.0° C.) substantially in a concurrent manner.

Next, referring to FIGS. 4 and 5, the second preferred embodiment of the second invention will be described as follows, wherein reference symbol A denotes a vapor insect killing apparatus.

This vapor heat insect killing apparatus A is different from that shown in the first preferred embodiment in which a plurality of rows of air circulating units 11, each comprised of an air conditioning chamber 21 and a fruit storing unit 31 in communication with the air conditioning chamber, are arranged side by side, with the air conditioning chamber 21 provided with forced circulating means 3 and heat exchanger means 4 and wherein a plurality of fruit storing units 31 (five in the preferred embodiment) are stored in the fruit processing chamber 1, and the air conditioning chamber 21 including the forced circulating means (fan) 3 and the heat exchanger means 4 is communicated with the fruit processing chamber 1.

As shown in FIG. 5, the vapor insect killing apparatus A is arranged such that both ends of the fruit processing chamber 1 have a rectangular shape, as seen in the top plan view of FIG. 5, and are provided with an inlet 7 and an outlet 8, a pair of roller conveyors D arranged in parallel to cross the inlet 7 and the outlet 8, a frame 5 serving as the pallets mounted over the roller conveyors D in such a way that the frame can move, and two air conditioning chambers 21 which are longitudinally communicated.

As shown in FIG. 4, each of the air conditioning chambers 21 communicate with an upper side passage 101 and a lower side passage 111 in regard to the fruit processing chamber 1, and the forced circulating means 3, the heat exchanger means 4 (including a heater, a hot water coil and a cooling coil and the like) are arranged inside the apparatus with the forced circulating means 3 being placed above the heat exchanger means 4.

As shown in FIG. 4, the fruit-storing units 31 are constituted by the container cages 6 mounted in multi-stage on the frame 5, a hood 121 arranged to cover the container cages 6 in the upper area and enabled to be moved up and down by a winding means (not shown), and an air blower means (fan) 9 arranged in the upper part of the hood 121. The fruit-storing units are stored in the fruit-processing chamber 1 while being moved by the roller conveyor D as shown. A space between each of the rollers (d) in the roller conveyor D below the frame 5 becomes the only air ascending space in the same manner as that of the aforementioned preferred embodiment, the space ascends from a lower part toward an upper part within the container cages 6 and the air is discharged into the air processing chamber 1 by the air blower means (fan) 9.

In addition, the fruit processing chamber 1 is provided with a temperature sensing means (a temperature sensor) C1 at a forward position of the lower side passage 111 and a relative humidity sensing means (a relative humidity sensor) C2; and each of the fruit storing units 31 is provided with a sensing means (a temperature sensor) C3 for sensing the central temperature of the fruits in the upper-most stage container cage 6.

In addition, a humidifier acting as the vapor supplying means C4 is arranged in the fruit processing chamber 1; the vapor supplying means C4, each of the sensing means C1, C2 and C3, the forced circulating means 3, the heat exchanger means 4 and the air blower means 9 are communicated with a control unit (not shown); and a vapor supplying amount, a heat exchanging rate of the heat exchanger means 4 and an air volume (a feeding amount) of the air blower means 9 are controlled by a predetermined program stored in either RAM or ROM in the control unit (not shown).

Reference numeral 41 denotes a circulating damper, reference numeral 21a denotes an air suction damper and reference numeral 131 denotes an air-discharging damper.

Next, referring to a control flow (not shown), an operation of the vapor heat insect killing apparatus of the second preferred embodiment will be described as follows.

When the apparatus is operated, the forced circulating means 3, the heat exchanger means 4 and the air blower means 9 are operated together. Air passes through the clearance of the frame 5 under an air blowing function of the air blower means 9, passes through the multi-stage container cages 6, loses heat to the fruits B, is blown out of the hood 121, thereafter the air is intermittently humidified by the vapor supplying means C4, sucked from the upperside passage 101 into the air conditioning chambers 21, 21, heated (heat exchanged) by the heat exchanger means 4 and then the air passes through the temperature sensing means C1 and the relative humidity sensing means C2 and is again fed into each of the fruit storing units 31 and becomes a circulating flow.

In the case of performing the operation of the apparatus of the present invention, at first the increasing step 1 (an increasing mode) is executed.

At this step 1, the vapor is intermittently atomized from the vapor supplying means (a humidifier) C4, the air containing the vapor is heat exchanged by the heat exchanger 4 at a predetermined heat exchanging rate increased in a stepwise manner so as to gradually increase a relative humidity of the saturated vapor passing through each of the fruit storing units 31 such that the inside temperature and then the central temperature of the fruits in each of the fruit storing units 31 is increased substantially in a concurrent manner up to a predetermined temperature (about 47.0° C.) after elapsing the predetermined time.

Subsequently, a continuing step 2 is executed. In step 2 the predetermined central temperature of the fruits is set and the heat exchanging rate and the vapor supplying amount (an intermittent atomization operation) are automatically selected to achieve the heating amount required for continuously maintaining the predetermined central temperature for a predetermined vapor heat processing time to kill the eggs and maggots of the fruit fly grown at the fruits B. The inside temperature and relative humidity are monitored in the fruit processing chamber 1.

During step 1, the central temperature of the fruits B in each of the fruit-storing units 31 is monitored by each of the fruit central temperature sensing means C3, and when an increase in the central temperature of the fruits in a certain fruit storing unit 31 is delayed due to the contained moisture or degree of ripen and size or the like at any point during monitoring such that a temperature difference of more than the set value is detected any fruits in the fruit storing units 31 then the operation is transferred to step 3.

At step 3, the air volume (a feeding amount) at the air blower means 9 is increased at the fruit storing unit 31 where the rate of increase in fruit central temperature is slow, the amount of heat supplied to the fruits therein is increased and the central temperature of the fruits in that fruit storing unit 31 is increased more quickly. That is, a feeding amount of saturated vapor per unit time flowing in the fruit storing unit 31 is increased and the heat supplied is increased such that the temperature difference of the central temperatures of the fruits is reduced to a value lower than the set value.

This control is executed automatically every time the temperature difference between the fruit central temperatures of any fruit storing units 31 becomes more than the set value.

When the temperature difference is reduced to a value lower than the set value, the operation returns back to step 1 to cause the central temperature of the fruits B stored in each of the fruit storing units 31 to be increased up to a predetermined temperature (about 47.0° C.) substantially in a concurrent manner.

FIG. 6 illustrates an example of modification (a third preferred embodiment) of the second preferred embodiment described above, wherein two pairs of roller conveyors D arranged in parallel to each other such that they both cross the inlet 7 and the outlet 8 of the fruit processing chamber 1. Each of the roller conveyors D, D is provided with a plurality of fruit storing units 31 (five in the preferred embodiment) in such a way that they can be moved.

Each of the fruit-storing units 31 has air blower means (fan) 9 for flowing air at the hood 121.

In a preferred embodiment, the items treated in Table 2 are merely spread to ten locations and the same control is utilized, so its description is not provided again.

Having described specific preferred embodiments of the invention with reference to the accompanying drawings, it will be appreciated that the present invention is not limited to those precise embodiments, and that various changes and modifications can be effected therein by one of ordinary skill in the art without departing from the scope of the invention as defined by the appended claims.

1-3. (canceled)

4. A vapor heat apparatus for killing insects or eggs on fruits, the apparatus comprising:
a fruit processing chamber housing fruit storage units for storing fruits;
air conditioning chambers provided with a heater and fan, each air conditioning chamber arranged in communication with one of the fruit storage units;
air circulation units for independently and forcedly blowing air through each fruit storage unit, each air circulation unit including means for supplying an amount of saturated vapor, means for sensing a fruit temperature at the center of the fruits, means for sensing a temperature of the air and means for sensing a relative humidity of the air; and
means for independently controlling the relative humidity in each of the fruit storage units by controlling the amount of vapor supplied and a heat exchanging rate of the heater in response to signals received from the means for sensing the fruit temperature.

5. The vapor heat apparatus of claim 1 each air conditioning unit receives air from a respective fruit storage unit and conditions the air before the air is drawn back into the respective fruit storage unit and is circulated by a respective air circulation unit.

6. The vapor heat apparatus of claim 2 wherein each air conditioning unit includes a fan for drawing the air into the air conditioning unit and for forcing the air into the respective fruit storage unit.

7. The vapor heat apparatus of claim 1 wherein the heater and the means for supplying vapor to a first fruit storage unit are controlled in reference to sensed signals of the means for sensing the fruit temperature such that when the fruit temperature in the first fruit storage unit is lower than the fruit temperature in a second fruit storage unit the relative humidity of the air in the first fruit storage unit is raised to cause the fruit temperature therein to rise.

8. The vapor heat apparatus of claim 4 wherein the relative humidity in the first fruit storage unit is raised relative to the relative humidity in other fruit storage units only when a difference between the fruit temperature in the first fruit storage unit and the fruit temperature in a specified fruit storage unit exceeds a certain value.

9. The vapor heat apparatus of claim 5 wherein the specified fruit storage unit is the fruit storage unit containing the fruit having the highest fruit temperature.

10. The vapor heat apparatus of claim 1 wherein the means for independently controlling the relative humidity in each of the fruit storage units provides for raising the fruit temperature of fruit having a low fruit temperature without raising the fruit temperature of fruit having a high fruit temperature.

11. A vapor heat apparatus for killing insects or eggs on fruit, the apparatus comprising:
a fruit processing chamber;
first and second fruit storage units positioned within the chamber for storing fruits therein, each storage unit having a fruit temperature sensor;
first and second air conditioning chambers, the first air conditioning chamber communicating only with the first unit and the second air conditioning chamber communicating only with the second unit, each air conditioning unit having a temperature sensor, a relative humidity sensor, a heater and a vapor supply;
a controller which activates the vapor supply in a respective air conditioning chamber to supply an increased amount of vapor if the fruit temperature in the respective fruit storage unit is lower than the fruit temperature in the other fruit storage unit.

12. The vapor heat apparatus of claim 8 wherein the controller activates the heater in the respective air conditioning chamber when the vapor supply is activated to control the relative humidity therein.

13. The vapor heat apparatus of claim 8 wherein the controller activates the vapor supply when a difference between the fruit temperatures exceeds a certain value.

14. The vapor heat apparatus of claim 8 wherein the fruit temperature in the respective fruit storage unit is raised without raising the fruit temperature in the other fruit storage unit.

15. A vapor heat apparatus for killing insects or eggs on fruits, the apparatus comprising:
a fruit processing chamber housing fruit storage units for storing fruits, the fruit processing chamber including means for supplying vapor into the air, means for sensing a temperature of the air and means for sensing a relative humidity of the air;
air conditioning chambers provided with a heater and fan and arranged in communication with the fruit processing chamber;
sensors for sensing a fruit temperature at the center of the fruit, a sensor positioned in each fruit storage unit;
fruit storage unit fans independently drawing air from the fruit processing chamber through each fruit storage unit, each fruit storage unit fan positioned in a respective fruit storage unit; and
means for independently controlling each fruit storage unit fan such that a delayed increase in fruit temperature in a first fruit storage unit causes the respective fruit storage fan to feed an increased amount of vapor into the first fruit storage unit to raise the fruit temperature of the fruits therein.

16. The vapor heat apparatus of claim 12 wherein the increased amount of vapor is drawn into the first fruit storage unit only when a difference between the fruit temperature in the first fruit storage unit and the fruit temperature in a specified fruit storage unit exceeds a certain value.

17. The vapor heat apparatus of claim 13 wherein the specified fruit storage unit is the fruit storage unit containing the fruit having the highest fruit temperature.

18. The vapor heat apparatus of claim 12 wherein the means for independently controlling each fruit storage fan provides for raising the fruit temperature of fruit having a low fruit temperature without raising the fruit temperature of fruit having a high fruit temperature.

19. A vapor heat apparatus for killing insects or eggs on fruits, the apparatus comprising:
a fruit processing chamber including a vapor supply, a temperature sensor and a relative humidity sensor;
air conditioning chambers provided with a heater and fan and arranged in communication with the fruit processing chamber;
first and second fruit storage units positioned within the chamber for storing fruits therein, each storage unit having a fruit temperature sensor and a fan for independently drawing air from the fruit processing chamber through the fruit storage unit; and
a controller which activates the fan in a respective fruit storage unit to draw in an increased amount of vapor if the fruit temperature in the respective fruit storage unit is lower than the fruit temperature in the other fruit storage unit such that the fruit temperature in the respective fruit storage unit is raised.

20. The vapor heat apparatus of claim 16 wherein the controller activates the fan in the respective fruit storage unit when a difference between the fruit temperatures exceeds a certain value.

21. The vapor heat apparatus of claim 16 wherein the fruit temperature in the respective fruit storage unit is raised without raising the fruit temperature in the other fruit storage unit.
